(19) United States
(12) Patent Application Publication
(10) Pub. No.: US 2013/0144923 A1
(43) Pub. Date: Jun. 6, 2013

(54) Quadratic Innovations for Skewed Distributions in Ensemble Data Assimilation

(71) Applicant: Daniel Hodyss, Pacific Grove, CA (US)

(72) Inventor: Daniel Hodyss, Pacific Grove, CA (US)

(21) Appl. No.: 13/690,093

(22) Filed: Nov. 30, 2012

Related U.S. Application Data
(60) Provisional application No. 61/566,069, filed on Dec. 2, 2011.

(51) Int. Cl. G06F 7/60

(52) U.S. Cl. CPC G06F 7/60
USPC 708/446

(57) ABSTRACT

Methods of computer-implemented data assimilation are presented which permit more accurately finding a posterior distribution and estimating the mean x̅ₐ of the posterior distribution for applications in which the prior distribution is not Gaussian, i.e., is “skewed.” The invention provides an improved Kalman filter, referred to herein as a “Quadratic Ensemble Filter,” which takes the conventional Kalman filter and adds a correction term that makes use of the third and fourth moment matrices of the probability density function ρ(x). In a general case, the Quadratic Ensemble Filter has the form

$${\underbrace{{\overline{x}}_{f} + Kv}}_{Kalman Filter} + {\underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}}_{Quadratic Correction Term}$$

and the mean X̅ₐ of the posterior can be estimated using the Quadratic Ensemble Filter, where

$${\overline{x}}_{a} = {\underbrace{{\overline{x}}_{f} + Kv}}_{Kalman Filter} + {\underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}}_{Quadratic Correction Term} .$$

### CROSS-REFERENCE

This application is a Nonprovisional of and claims the benefit of priority under 35 U.S.C. §119 based on U.S. Provisional Patent Application No. 61/566,069 filed on Dec. 2, 2011, the entirety of which is hereby incorporated by reference into the present application.

### TECHNICAL FIELD

The present invention relates to ensemble data assimilation and in particular to reducing errors in the state estimate from observations in nonlinear systems.

### BACKGROUND

Ensemble-based data assimilation is rapidly becoming the technique of choice for the estimation of the state of a geophysical system.

The goal of data assimilation is to provide the user with an estimate of the state of a noisy system from noisy observations with the smallest possible mean squared error in the estimate of that state.

In data assimilation, a probability distribution function (pdf) ρ(x|y, x_{f}) estimating the state of a system, known as a “posterior,” can be estimated from a prior modeled state and a set of observations according to Bayes' Rule:

$$ρ ( x \vert y , {x}_{f} ) = \frac{ ρ ( y \vert x ) ρ ( x \vert {x}_{f} )}{{\int }_{- ∞}^{∞} ρ ( y \vert x ) ρ ( x \vert {x}_{f} ) d x} , \qquad ( 1 )$$

where ρ(y|x) describes the conditional distribution of observations y given a particular value of the truth (observation likelihood), while ρ(x|x_{f}) describes a conditional distribution of truth, referred to as the “prior,” that has been derived given a previous estimate of the true state.

The state of a physical system is often estimated by the mean of the posterior x̅, where

$$\overline{x} ( y , {x}_{f} ) = {\int }_{- ∞}^{∞} x ρ ( x \vert y , {x}_{f} ) d x ,$$

because this quantity is unbiased and has the smallest possible mean square error. See A. H. Jazwinski, Stochastic processes and filtering theory, Academic Press, 376 pp. (1998).

However, x̅ is impossible to know exactly for any general particular physical system, and so techniques to best estimate this quantity have been the subject of much research in the data assimilation field.

A physical system in which the user wishes to know the state of that physical system and cannot because of their inability to measure its properties with infinite precision is often referred to as a “noisy” system. All real-world physical systems are noisy because it is impossible in practice to produce an observation with infinite precision, i.e. the observations also are noisy.

The most popular technique for estimating x̅ in a noisy system from a set of noisy observations y is that of using a Kalman filter x̅_{f}+Kv, such that

x̅ₐ= x̅_{f}+Kv,

where x̅ₐ is the Kalman filter's estimate of the posterior mean, x̅_{f} is the mean of the prior distribution, v=y−H x̅_{f} is known in the art as the “innovation,” and K=P_{f}H^{T}(HP_{f}H^{T}+R)⁻¹, where P_{f} is the second moment of the prior distribution, or the “covariance” matrix determined from the prior distribution; R is the second moment of the observation likelihood, or the “covariance” matrix determined from the observation likelihood; and H is the operator that takes the state vector to the observations. See Kalman, R. E., 1960: “A new approach to linear filtering and prediction problems,” J. Basic Eng., 82, 35-45.

In many applications, x̅_{f} and P_{f} are estimated using Monte Carlo (ensemble) methods and in such cases the method is referred to as an Ensemble Kalman Filter (EnKF). See Evenson, G., 1994: “Sequential data assimilation with a nonlinear quasi-geostrophic model using Monte-Carlo methods to forecast error statistics,” J. Geophys. Res., 99, 143-162; and Evenson, G., 2003: “The Ensemble Kalman Filter: Theoretical formulation and practical implementation,” Ocean Dyn., 53, 343-367.

The use of Kalman Filter techniques in the meteorological community has been met with considerable success in a wide range of applications within the fields of atmospheric, oceanic, and hydrologic sciences. Examples include the simulation of mid-latitude and tropical cyclones, tropical convective storms, as well as parameter estimation for forecast model tuning See, e.g., Houtekamer, P. L., H. L. Mitchell, G. Pellerin, M. Buehner, M. Charron, L. Spacek, and B. Hansen, 2005: “Atmospheric data assimilation with an ensemble Kalman filter: Results with real observations,” Mon. Wea. Rev., 133, 604-620; Szunyogh, I., E. J. Kostelich, G. Gyarmati, E. Kalnay, B. R. Hunt, E. Ott, E. Satterfield, and J. A. Yorke, 2008: “A local ensemble transform Kalman filter data assimilation system for the NCEP global model,” Tellus, 60A, 113-130; Meng, Z., and F. Zhang, 2008: “Tests of an ensemble Kalman filter for mesoscale and regional-scale data assimilation, Part IV: Comparison with 3DVAR in a month-long experiment,” Mon. Wea. Rev., 136, 3671-3682; Torn, R. D., and G. J. Hakim, 2008: “Performance characteristics of a pseudo-operational ensemble Kalman filter,” Mon. Wea. Rev., 136, 3947-3963; Whitaker, J. S., T. M. Hamill, X. Wei, Y. Song, and Z. Toth, 2008: “Ensemble data assimilation with the NCEP global forecast system,” Mon. Wea. Rev., 136, 463-482; and Anderson, J., T. Hoar, K. Raeder, H. Liu, N. Collins, R. Torn, and A. Avellano, 2009: “The Data Assimilation Research Testbed: A community facility,” Bull. Amer. Meteor. Soc., 90, 1283-1296.

There are, however, several unresolved issues with the application of the EnKF to the highly nonlinear dynamics inherent to data such as meteorological flows at high resolution. It has been speculated that one reason the assimilation in these situations is sometimes difficult is the fact that the relationship between the observed variables and the state-vector is nonlinear. This nonlinear relationship leads to skewed prior and posterior distributions, so that the mean of the posterior is not accurately found using a conventional EnKF.

Situations in which the EnKF is known to have some difficulty, and where such skewed distributions may be the culprit, include the assimilation of vortex position (Lawson, G. W., and J. A. Hansen, 2005: “Alignment error models and ensemble-based data assimilation,” Mon. Wea. Rev., 133, 1687-1709; and Chen, Y., and C. Snyder, 2007: “Assimilating vortex position with an ensemble Kalman filter,” Mon. Wea. Rev., 135, 1828-1845); radar observations (Dowell, D. C., L. J. Wicker, and C. Snyder, 2011: “Ensemble Kalman filter assimilation of radar observations of the 8 May 2003 Oklahoma City supercell: Influences of reflectivity observations on storm-scale analyses,” Mon. Wea. Rev., 139, 272-294); parameter estimation (Hacker, J. P., C. Snyder, S.-Y. Ha, and M. Pocernich, 2011: “Linear and non-linear response to parameter variations in a mesoscale model,” Tellus, 63A, 429-444; Posselt, D. J. and C. H. Bishop, 2012: “Nonlinear parameter estimation: Comparison of an ensemble Kalman smoother with a markov chain monte carlo algorithm,” Mon. Wea. Rev., 140, 1957-1974); and observations over a long assimilation window (Khare, S. P., J. L. Anderson, T. J. Hoar, and D. Nychka, 2008: “An investigation into the application of an ensemble Kalman smoother to high-dimensional geophysical systems,” Tellus, 60A, 97-112).

Thus, there is a need for a better method for finding the posterior mean in such nonlinear cases, where the prior—and therefore the posterior—distribution is skewed.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides improved methods of computer-implemented data assimilation which permit more accurately finding the mean x̅ₐ of a posterior distribution for cases in which the prior distribution is not Gaussian, i.e., is “skewed.”

The present invention provides an improved Kalman filter, referred to herein as a “Quadratic Ensemble Filter,” which includes a new term denoted herein as the “Quadratic Correction Term.” In a general case, the Quadratic Ensemble Filter in accordance with the present invention can take the form:

$${\underbrace{{\overline{x}}_{f} + Kv}}_{Kalman Filter} + {\underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}}_{Quadratic Correction Term} .$$

This Quadratic Ensemble Filter can also take other forms, depending on the type of data assimilation in which it is applied, but in all cases, the Quadratic Correction Term in the Quadratic Ensemble Filter in accordance with the present invention makes use of the third and fourth moment matrices of the probability density function ρ(x), where the third moment matrix is T_{f} and the fourth moment matrix F_{f} is contained within II, whereas the conventional Kalman filter makes use only of the second moment matrix P_{f} contained within K.

The present invention provides a method for finding the mean of a skewed posterior distribution in a computer-implemented data assimilation system. In accordance with the present invention, a computer programmed with appropriate software receives ensemble data describing a prior distribution ρ(x|x_{f}) and a set ρ(y|x) of observations y which implies a posterior distribution ρ(x|y, x_{f}), where the prior distribution—and therefore the posterior distribution—is not Gaussian but instead is skewed, and can therefore estimate the mean of such a skewed posterior distribution by applying the Quadratic Ensemble Filter of the present invention and finding x̅ₐ, where

$${\overline{x}}_{a} = {\underbrace{{\overline{x}}_{f} + Kv}}_{Kalman Filter} + {\underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}}_{Quadratic Correction Term} .$$

In accordance with the present invention, the Quadratic Ensemble Filter can be applied in two additional exemplary operational implementations that are common to the art.

In a first exemplary implementation, the present invention provides a method for finding a posterior mean in a data assimilation system that uses serial observation processing, in which the computer receives ensemble data that includes a prior ensemble distribution and a set of observations i=1, . . . , p and updates the prior after assimilating each of a given set of observations. A serial observation processing algorithm is useful in situations with a far greater number of observations than can conveniently be stored in memory on memory-limited computing architectures. In a serial observation processing algorithm only a single observation and its corresponding ensemble need be stored in memory. The skewness in such a system is reflected in the third moment between each observation i and the state variables to be updated. In this first exemplary implementation, a serial Quadratic Ensemble Filter in accordance with the present invention processes the “squared” observations in the innovation as if they were traditional observations.

In this implementation, the computer assimilates all the “squared” observations through a Quadratic Ensemble Filter having the form x̅ᵢ+Qᵢ[vᵢ²−(Pᵢ+Rᵢ)], such that

x̅ₛ= x̅ᵢ+Qᵢ[vᵢ²−(Pᵢ+Rᵢ)] for each ith observation,

where

x̅ᵢ= x̅ₛ for the ith-1 observation,

and

Qᵢ=ZᵢZᵢ^{2T}Hᵢ^{T}(Fᵢ+6RᵢPᵢ+R₄ᵢ−(Pᵢ+Rᵢ)²)⁻¹,

with an ensemble update of

Pᵢ₊₁=Pᵢ−QᵢTᵢ.

After all 1, . . . , p “squared” observations have been assimilated, then all 1, . . . p “unsquared” observations are assimilated with a traditional Kalman filter for the ith observation such that

x̅ᵤ= x̅ᵢ+Kᵢvᵢ,

where

x̅ᵢ= x̅ᵤ for the ith-1 observation,

and

Kᵢ=ZᵢZᵢ^{T}Hᵢ^{T}/(Pᵢ+Rᵢ),

with an ensemble update of the form:

Pᵢ₊₁=Pᵢ−KᵢPᵢ.

The mean x̅ₐ of the posterior distribution is found when the last unsquared observation has been assimilated, i.e.,

x̅ₐ= x̅ᵤ for the pth observation.

A second exemplary implementation of a computer-implemented method for finding the posterior distribution and estimating the posterior mean in accordance with the present invention proceeds with global observation processing, in which all observations are considered at one time. In this embodiment, the Quadratic Ensemble Filter can take the form x̅_{f}+z\hat{z}^{T}Ĥ^{T}(Ĥ\hat{P}_{f}Ĥ^{T}+\hat{R})⁻¹\hat{v}′, where x̅_{f} is a vector of the prior mean, \hat{v}′ includes the square of the innovation, \hat{P}_{f} is the prior forecast error covariance matrix, Ĥ is the observation operator matrix that takes the state vector to the observations, and \hat{R} is the observation covariance matrix determined from the observation likelihood.

Using this form of Quadratic Ensemble Filter, the computer can estimate x̅ₐ, the mean of the posterior by using a minimization approach, wherein

x̅ₐ= x̅_{f}+Z\hat{Z}^{T}Ĥ^{T}(Ĥ\hat{P}_{f}Ĥ^{T}+\hat{R})⁻¹\hat{v}′.

### BRIEF DESCRIPTION OF THE DRAWINGS

FIGS. 1A, 1B, and 1C depict three exemplary probability density functions with the first, second, and third moments of each and depicting the pdfs as being left skewed (FIG. 1A), not skewed (FIG. 1B), or right skewed (FIG. 1C) based on the value of their third moment.

FIGS. 2A, 2B, and 2C illustrate aspects of the calculation of the posterior distribution and the posterior mean from a skewed prior distribution using a conventional Kalman Filter and using a Quadratic Ensemble Filter in accordance with the present invention.

FIG. 3 illustrates an exemplary process flow for a method for finding the mean x̅ₐ of a skewed posterior distribution with a Quadratic Ensemble Filter in accordance with the present invention using the Quadratic Correction Term approach.

FIGS. 4A-4B illustrate an exemplary process flow for a first exemplary implementation of a method for finding the mean x̅ₐ of a skewed posterior distribution using a Quadratic Ensemble Filter in accordance with the present invention using a serial-solve approach.

FIGS. 5A-5B illustrate an exemplary process flow for a second exemplary implementation of a method for finding the mean x̅ₐ of a skewed posterior distribution with a Quadratic Ensemble Filter in accordance with the present invention using a global-solve approach.

FIGS. 6A-6F illustrate aspects of the advantages of using a Quadratic Ensemble Filter in accordance with the present invention for cases where the system being estimated is a nonlinear Lorenz system.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention provides improved methods of computer-implemented data assimilation which can provide more accurate estimates of the true state of a physical system in cases where the prior distribution and therefore the posterior distribution—is not Gaussian, i.e., is “skewed.”

In data assimilation, the best estimate of the true state of a physical system is the one that exhibits the smallest possible mean squared error. The quantity that has been found to provide this smallest possible mean squared error is x̅, the mean of the posterior distribution. The goal of the method of the present invention is to provide a better estimate of x̅ than can be provided by a conventional Kalman filter in cases where the physical system (i.e. the prior distribution) exhibits significant skewness.

Thus, as described in more detail below, the present invention provides an improvement to the conventional Kalman filter commonly used in data assimilation and data processing and further provides methods for data assimilation using this improved filter that can provide improved predictions of the posterior and its properties in cases where the probability density functions exhibited by the data are skewed.

As noted above, data assimilation combines information from a prior state, a set of observations, and a model to obtain an estimate of the state of some physical system that is better than either the observations or the model by themselves. The object that is obtained when information regarding the prior state, the observations, and the estimated state are combined into a single entity is known as the “posterior” and is expressed by a set of probability density functions (pdfs) that describe the probability that one or more events may occur. The posterior is derived from a combination of data of the prior state, the observations, and the model by means of Bayes' rule in Equation (1) set forth above and repeated here for ease of reference:

$$ρ ( x \vert y , {x}_{f} ) = \frac{ ρ ( y \vert x ) ρ ( x \vert {x}_{f} )}{{\int }_{- ∞}^{∞} ρ ( y \vert x ) ρ ( x \vert {x}_{f} ) d x} , \qquad ( 1 )$$

where ρ(y|x) describes the conditional distribution of observations given a particular value of the truth (observation likelihood), while ρ(x|x_{f}) describes a conditional distribution of truth, referred to as the “prior,” that has been derived given a previous estimate of the true state. A skewed prior pdf will result in a skewed posterior. The skewness of a distribution can be determined mathematically by calculating its first, second, and third moments. It should be noted that, for simplicity and ease of understanding, scalar notation is used in the description below regarding calculation of the moments of a distribution, whereas in the description of the Quadratic Ensemble Filter below, the matrix forms are used.

Thus, using scalar notation, the first moment of the distribution ρ(x) estimates its mean, x̅:

$$\overline{x} = {\int }_{- ∞}^{∞} x ρ ( x ) d x , \qquad ( 2 )$$

where x is a possible true state of the system.

The second moment of the distribution ρ(x) estimates its variance, σ²:

$${σ}^{2} = {\int }_{- ∞}^{∞} {( x - \overline{x} )}^{2} ρ ( x ) d x . \qquad ( 3 )$$

The third moment of the distribution ρ(x) estimates the degree to which the distribution differs from being symmetric about its mean, T:

$$T = {\int }_{- ∞}^{∞} {( x - \overline{x} )}^{3} ρ ( x ) d x . \qquad ( 4 )$$

A distribution is considered to be “left-skewed” if the value of its third moment T is less than zero, is considered to be “right-skewed” if the value of its third moment T is greater than zero, and is considered to have no skew if the value of its third moment T is zero.

The inventor of the present invention has shown that there are two important situations in which skewness in the prior/posterior distribution will lead to significant differences between the true posterior mean and that estimated from an EnKF. See Hodyss, D., 2011: “Ensemble State Estimation for Nonlinear Systems Using Polynomial Expansions in the Innovation,” Mon. Wea. Rev. 139, 3571-3588 (Hodyss 2011); and Hodyss, D., 2012: “Accounting for Skewness in Ensemble Data Assimilation,” Mon. Wea. Rev. 140, 2346-2358 (Hodyss 2012), both of which are hereby incorporated by reference into the present disclosure in their entirety.

As described in Hodyss 2012, the EnKF estimate of the posterior mean x̅ may be written as

$${\overline{x}}_{a} = {\overline{x}}_{f} + \frac{P}{P + R} v ,$$

where, as described above, x̅_{f} is the prior mean, xₐ is the EnKF's estimate of the posterior mean x̅, P is a scalar forecast error variance and R is a scalar observation error variance. This form of the EnKF shows that the EnKF makes a correction to the prior mean that goes linearly with the innovation.

However, depending on the direction of the skewness (i.e., the sign of the third moment) of the posterior and the sign of the innovation, this correction will either be too large or too small. This is due to the fact that the true posterior mean is a curved (nonlinear) function of the innovation whenever the posterior has significant skewness.

As described in Hodyss 2012, the curvature of the posterior mean x̅ can be expressed in terms of the third moment T of the posterior, i.e.,

$$\frac{{d}^{2} \overline{x}}{d {v}^{2}} = \frac{T}{{R}^{2}} .$$

### See Hodyss 2012 at p. 2347.

The first situation in which skewness is a significant issue for an EnKF is when the innovation v is very large, i.e. |v|>>\sqrt{P+R}, where P is a scalar forecast error variance and R is a scalar observation error variance. In such a case, because the EnKF estimate is a linear function of the innovation, and the posterior mean from a skewed distribution is in fact a curved—rather than a linear—function of the innovation, a large innovation in an EnKF algorithm will always result in an estimate of the posterior mean that is either larger or smaller than the true posterior mean.

The second, and possibly more surprising, situation in which skewness is a significant issue for an EnKF occurs when the innovation is very small, i.e., where |v|>>\sqrt{P+R}. In such a case, the estimate of the posterior mean x̅ using the EnKF reduces to xₐ≠ x̅_{f}. However, when there is significant skewness in the prior distribution, the prior mean xₐ is not a good estimate of the posterior mean.

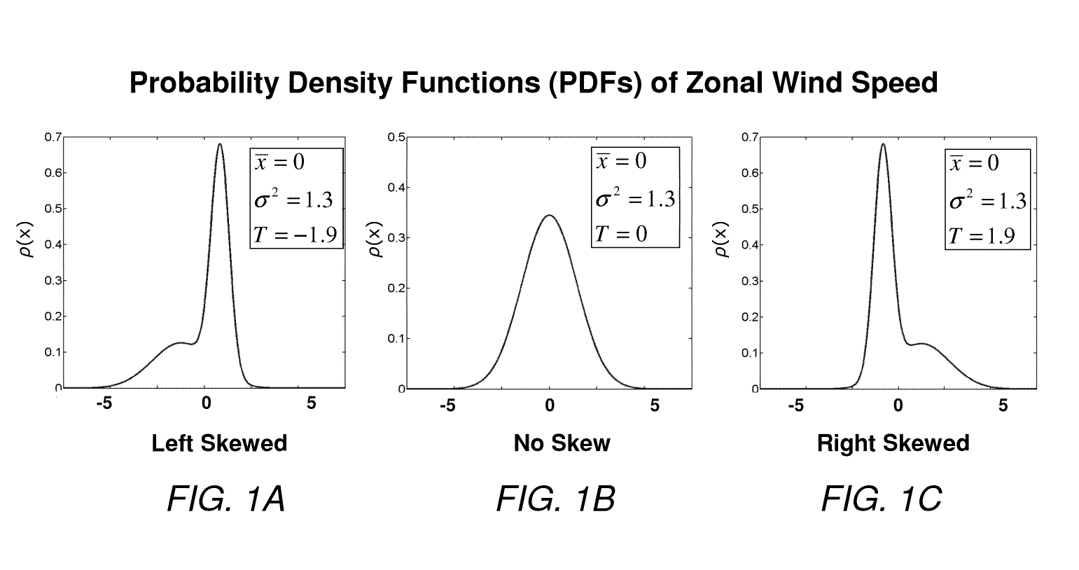

FIGS. 1A-1C illustrate exemplary pdfs that illustrate these aspects of skewness of a distribution. As can be seen in FIGS. 1A-1C, while all three plots have a first moment x̅ of 0 and a second moment σ² of 1.3, they have different third moments T, which is reflected in the shape of the distribution. Thus, the distribution shown in FIG. 1A has a third moment T of −1.9, i.e., that is less than zero, and its plot is noticeably left-skewed. Similarly, the distribution shown in FIG. 1C has a third moment T of +1.9, i.e., that is greater than zero, and its plot is noticeably right-skewed. In contrast, the distribution shown in FIG. 1B has a third moment T of 0, and its plot exhibits no skew.

As noted above, such skewed prior distributions and skewed observation likelihood distributions generally result in skewed posterior distributions. Skewed posterior distributions are difficult for the Kalman filter to estimate properly because the Kalman filter assumes that the distribution is normal, i.e., Gaussian.

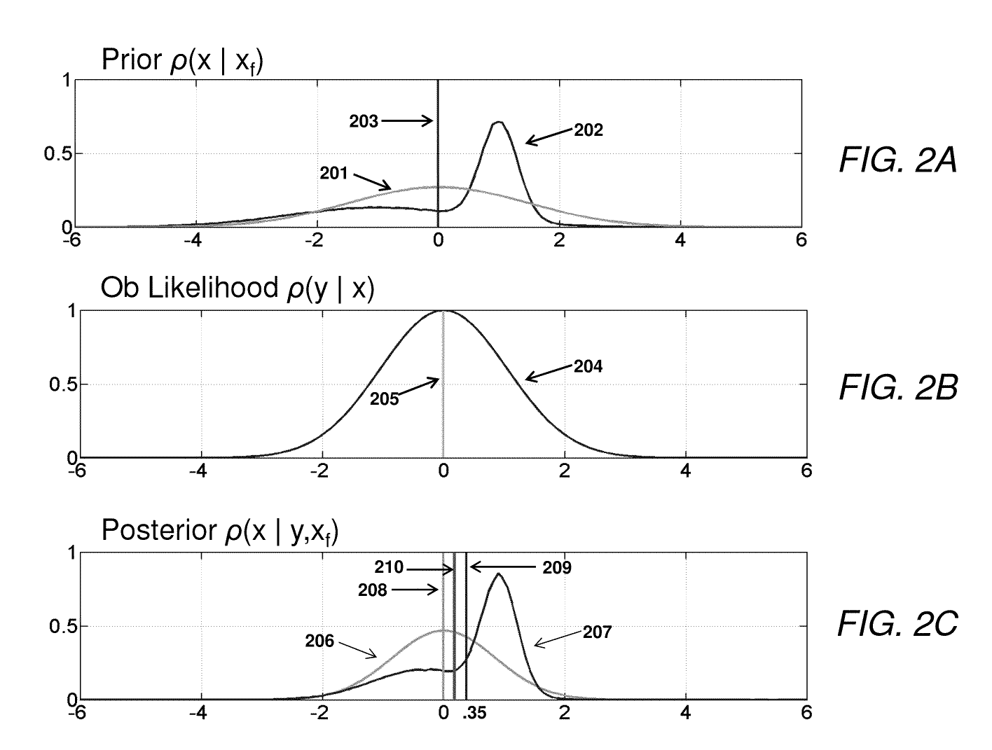

An example of these problems is illustrated in the plots shown in FIGS. 2A-2C.

FIG. 2A shows a prior distribution 202 and a Gaussian approximation 201 of that prior distribution which is consistent with the assumptions of the Kalman filter. The actual distribution 202 has a negative third moment and, as can be seen from FIG. 2A, exhibits a significant left skew, while the approximation 201 has a third moment of zero and does not exhibit any skew. Both prior distributions 202 and 201 have a mean x̅_{f} (shown by line 203) of zero.

FIG. 2B shows the observation likelihood distribution 204 plotted as a function of the state (x) for an observation of y=0, where the observation distribution 204 is a Gaussian having a mean 205 of zero.

Applying Bayes' rule (Equation (1)) to observation likelihood distribution 204 and prior distributions 201 and 202 results in the posterior distributions 206 and 207, respectively, shown in FIG. 2C. As shown in FIG. 2C, posterior distribution 206, which is based on application of Bayes' rule to the approximated prior distribution 201 and observation likelihood 204, is Gaussian. In contrast, application of application of Bayes' rule to the actual, skewed, prior 202, results in posterior distribution 207 which, like the prior distribution, is highly skewed.

Using a traditional Kalman filter to find the posterior mean x̅ₐ of posterior distributions 206 and 207 results in a finding of x̅ₐ=0, represented by line 208 in FIG. 2C, for both distributions. This is because in the traditional Kalman filter, x̅ₐ= x̅_{f}+Kv, where v=y−H x̅_{f} and x̅_{f} is the mean of the prior distribution, and so if y=0 and x̅_{f}=0, the innovation v in the Kalman filter is zero, and x̅ₐ= x̅_{f}+Kv implies that x̅ₐ= x̅_{f}=0.

However, as seen in FIG. 2C and as described further below, the posterior distribution produced using skewed true prior distribution 202 has a non-zero mean represented by line 209. The Kalman filter does not provide an accurate estimate of the posterior distribution mean because the Kalman filter assumes that there is no skewness in the prior. However, the prior distribution was in fact strongly skewed, and this caused a significant error in the Kalman filter's estimate of the posterior mean. It is important to note that in both cases the innovation v was zero, and therefore one should realize that the inaccuracy of the Kalman filter in the case of skewed distributions is not just an issue where the innovation v is large but is but actually an issue with all skewed distributions, irrespective of the size of the innovation.

As described in more detail below, in contrast to the conventional Kalman filter, the Quadratic Ensemble Filter in accordance with the present invention makes a correction, shown by line 210 in FIG. 2C, in the case that the innovation is zero. The error in the estimate of the posterior mean made by the conventional Kalman filter has been reduced by approximately 50% as a result of the correction included in the Quadratic Ensemble Filter in accordance with the present invention.

Thus, as described in more detail below, the present invention provides an improved Kalman filter which provides better state estimates in cases where the prior—and therefore the posterior—distribution is skewed and provides methods for making state estimates in such cases using the improved Kalman filter.

In a general case, an improved Kalman filter in accordance with the present invention, denoted herein as a “Quadratic Ensemble Filter” that in a general case can take the form:

$${\underbrace{{\overline{x}}_{f} + Kv}}_{Kalman Filter} + {\underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}}_{Quadratic Correction Term} \qquad ( 4 )$$

so that the mean x̅ₐ of such a skewed posterior distribution can be found by applying the Quadratic Ensemble Filter of the present invention, where

$${\overline{x}}_{a} = {\underbrace{{\overline{x}}_{f} + Kv}}_{Kalman Filter} + {\underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}}_{Quadratic Correction Term} . \qquad ( 4 )$$

As can be seen from Equation (4), the Quadratic Ensemble Filter in accordance with the present invention takes the traditional Kalman Filter x̅_{f}+Kv described above and adds a new term, denoted herein as a “Quadratic Correction Term” in which I is the identity matrix, π is the expected fourth moments matrix derived as described below, T_{f} is the third moment matrix determined from the prior distribution, and v^{2′}=v²− [symbol] v² [symbol] is a quadratic term of the innovation, with v² representing a vector of length p² such that

v²=(v\hat{×}v)=[v₁v^{T} v₂v^{T} . . . vₚv^{T}]^{T}, (4)

where the symbol “\hat{×}” refers to the Kronecker product and vᵢ is the ith element of the innovation vector.

As described in more detail below, the Quadratic Ensemble Filter in accordance with the present invention can also take alternative forms, depending on the type of data assimilation in which it is applied, but in all cases, the Quadratic Correction Term in the Quadratic Ensemble Filter in accordance with the present invention makes use of the third and fourth moment matrices of the prior distribution, whereas the conventional Kalman filter makes use only of the second moment matrix.

A brief discussion of the derivation of the Quadratic Ensemble Filter will now be presented. Additional details regarding the derivation of the Quadratic Ensemble Filter in accordance with the present invention can be found in Hodyss 2011, supra.

As noted above, a standard estimation technique for finding the true state given the posterior density is to find its mean, i.e.

$$\overline{x} ( y , {x}_{f} ) = {\int }_{- ∞}^{∞} x ρ ( x \vert y , {x}_{f} ) d x . \qquad ( 5 )$$

This estimate of the true state has the property that it is unbiased and that it minimizes the posterior error variance. See Jazwinski, A. H., 1998: “Stochastic processes and filtering theory,” Academic Press, at pp. 145-150. In ensemble-based estimation techniques it is often assumed that our previous estimate of the truth is the mean of the prior distribution, x̅_{f}. Note that a random draw from the prior distribution behaves as x= x̅_{f}+ε_{f}, where ε_{f} is a random variable with zero mean. This allows Equation (5) to be written as

$$\overline{x} ( y , {\overline{x}}_{f} ) = {\overline{x}}_{f} + {\int }_{- ∞}^{∞} {ɛ}_{f} ρ ( {ɛ}_{f} \vert y , {\overline{x}}_{f} ) d {ɛ}_{f} . \qquad ( 6 )$$

Without loss of generality we may consider the right-hand side of Equation (6) as simply an unknown function of today's observation and prior mean. By taking this perspective, Equation (6) may be written concisely as

x̅− x̅_{f}=f(y, x̅_{f}) (7)

The vector-function f is assumed smooth and is the object of central interest. One way to estimate the structure of f is through an expansion in terms of the observation about the prior estimate of that observation, i.e.

x̅− x̅_{f}=f₀+M₁v+M₂v²+ . . . (8)

where the innovation v=y−H x̅_{f}, the matrix H is the observation operator that takes the N-dimensional state vector, x̅_{f}, into the p-dimensional observation space, and the vector fₒ=f(v=0) and the matrix coefficients of the expansion, Mᵢ, are as determined below.

As noted above with respect to Equation (4), the vector notation v² represents a vector of length p² such that

v²=(v\hat{×}v)=[v₁v^{T} v₂v^{T} . . . vₚv^{T}]^{T}, (9)

where the symbol “\hat{×}” refers to the Kronecker product and vᵢ is the ith element of the innovation vector. A similar representation applies to the p³-vector v³ and so on.

The entire polynomial expansion in Equation (8) may formally be represented as

x̅− x̅_{f}=f₀+G\hat{v} (10)

where

G=[M₁ M₂ . . . M_{∞}], (11)

and

\hat{v}=[v^{T} v^{2T} . . . v^{∞T}]^{T}. (12)

Equation (10) describes how to calculate the mean of the posterior using the “linear” update involving the gain matrix G operating on the innovation \hat{v}, where \hat{v} is comprised of an infinite number of predictors formed from today's innovation.

To determine the vector f₀ we note that a random draw from the posterior distribution is x= x̅+ε, where ε is a random variable with zero mean describing the fluctuations around the posterior mean associated with our uncertainty in the state. Therefore, an equation for the “error” in estimating the true state as the posterior mean may be obtained by substituting for x̅ and x̅_{f} as described above on both sides of Equation (13):

ε=ε_{f}−(f₀+G\hat{v}). (12)

Because the expected value of ε and ε_{f} must vanish this implies that

f₀=−G [symbol] \hat{v} [symbol] (12)

where

[symbol]

\hat{v} [symbol] =[ [symbol] v [symbol] ^{T} [symbol] v² [symbol] ^{T} . . . ]^{T}, (12)

and the notation [symbol] [symbol] represents the expected value of a random variable.

By truncating the polynomial at the quadratic term and minimizing the trace of the expected error covariance matrix we find

f₀=−(I−KH)T_{f}H₂^{T}π⁻¹ [symbol] v² [symbol] , (12)

M₁=K−(I−KH)T_{f}H₂^{T}π⁻¹H₂T_{f}^{T}H^{T}(HP_{f}H^{T}+R)⁻¹, (12)

M₂=(I−KH)T_{f}H₂^{T}π⁻, (12)

and

π=H₂F_{f}H₂^{T}+A+B+C+R₄−H₂T_{f}^{T}H^{T}(HP_{f}H^{T}+R)⁻¹HT_{f}H₂^{T}− [symbol] v² [symbol] [symbol] v^{2T} [symbol] (12)

More specifically,

P_{f}= [symbol] ε_{f}ε_{f}^{T} [symbol] , (12)

where P_{f} is the second moment, or “covariance,” matrix for the prior;

T_{f}= [symbol] ε_{f}ε_{f}^{2T} [symbol] , (12)

where T_{f} is the third moment matrix for the prior;

F_{f}= [symbol] ε_{f}²ε_{f}^{2T} [symbol] , (12)

where F_{f} is the fourth moment matrix for the prior;

R= [symbol] ε₀ε₀^{T} [symbol] , (12)

where R is the second moment, or “covariance,” matrix for the observations;

R₃= [symbol] ε₀ε₀^{2T} [symbol] , (12)

where R₃ is the third moment matrix for the observations;

R₄ [symbol] ε₀²ε₀^{2T} [symbol] , (12)

where R₄ is the fourth moment matrix for the observations;

A= [symbol] ε₀²(Hε_{f})^{2T} [symbol] + [symbol] (Hε_{f})^{2T}ε₀^{2T} [symbol] ; (12)

B=R\hat{×}HP_{f}H^{T}+HP_{f}H^{T}\hat{×}R; (12)

C= [symbol] (ε₀ε_{f}^{T}H^{T})\hat{×}(Hε_{f}ε₀^{T}) [symbol] + [symbol] (Hε_{f}ε₀^{T})\hat{×}(ε₀ε_{f}^{T}H^{T}) [symbol] , (12))

where ε_{f}=x− x̅_{f} represents an error drawn from the prior distribution, ε₀ represents an error (e.g., an instrument error around the true value) drawn from the observation likelihood, and H₂=H\hat{×}H is the matrix operator that takes an N² vector into the p² predictor space.

Putting the matrices in Equations (12)-(12) into Equation (8), we get the general form of the Quadratic Ensemble Filter of the present invention set forth above as Equation (4):

$$\underbrace{{\overline{x}}_{f} + Kv}_{Kalman Filter} + \underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}_{QuadraticCorrectionTerm} .$$

As described in more detail below, the Quadratic Ensemble Filter in accordance with the present invention can also take alternative forms, depending on the type of data assimilation in which it is applied, but in all cases, the Quadratic Correction Term in the Quadratic Ensemble Filter in accordance with the present invention makes use of the third and fourth moment matrices of the prior distribution, whereas the conventional Kalman filter makes use only of the second moment matrix.

The third moment matrix T_{f} and the fourth moment matrices F_{f} and R₄ in the matrix II appear in the Quadratic Correction Term of the Quadratic Ensemble Filter in conjunction with the nonlinear, squared innovation v^{2′}=v²− [symbol] v² [symbol] .

As noted above, the problem with Kalman filtering for skewed distributions results from the fact that all skewed posterior distributions have posterior means that are a nonlinear function of the innovation. This is a significant issue for a Kalman filter because it is a linear function of the innovation. Therefore, the Kalman filter cannot provide the curved (or nonlinear) estimate of the posterior mean required in physical systems that develop skewed posterior distributions. On the other hand, because the Quadratic Ensemble Filter in accordance with the present invention explicitly includes v^{2′}, the quadratic form of the innovation, in combination with a non-zero third moment T, it provides a curved estimate of the posterior mean at any time that the posterior distribution is skewed. In addition, if the third moment T is zero, i.e., the posterior distribution is not skewed, the Quadratic Ensemble Filter in accordance with the present invention reduces to a conventional Kalman filter. Thus, the Quadratic Ensemble Filter can automatically provide the correct answer in both skewed and non-skewed systems.

FIG. 2C illustrates the advantages provided by the Quadratic Ensemble Filter in accordance with the present invention in the cases where the prior and therefore the posterior distribution is skewed.

As discussed above, the plots in FIG. 2C, show a posterior distribution (plot 207) from a Gaussian prior distribution 201 having a mean x̅_{f} of zero combined with a Gaussian observation distribution and a posterior distribution (plot 206) from a skewed prior distribution 202, also having a mean x̅_{f} of zero, combined with the Gaussian observation distribution. As discussed above, because x̅_{f}=0 and y=0, using a traditional Kalman filter analysis, the mean x̅ₐ of the posterior distribution in both cases is found to be zero. However, in this simple idealized case we may directly calculate the posterior mean and find that its value is 0.35, as shown by line 209. This error in the calculation of the posterior mean is immediately seen to be significant if compare the error against the standard deviation of the true posterior. The standard deviation of the true posterior is about 0.85, which shows that the error in the Kalman estimate of the posterior mean is about 45%.

In contrast, using a Quadratic Ensemble Filter in accordance with the present invention, we obtain a non-zero posterior mean x̅ₐ, shown by plot 210, which is closer to the real truth. In contrast to the Kalman filter, the Quadratic Ensemble Filter makes a correction, shown by line 210, in this case where the innovation is zero. The error in the estimate of the posterior mean made by the Kalman filter has thus been reduced by approximately 50%.

Thus, by using a Quadratic Ensemble Filter in accordance with the present invention, which employs a nonlinear innovation and the third and fourth moments of the prior distribution, a much improved estimate of the posterior mean can be obtained in cases where the prior—and therefore the posterior—distribution is skewed.

A general case and two additional exemplary embodiments of a method for estimating the mean of a skewed posterior distribution using a Quadratic Ensemble Filter in accordance with the present invention will now be presented. One skilled in the art will readily understand that many other applications and embodiments of a Quadratic Ensemble Filter are possible, and all such applications and embodiments are considered to be within the scope and spirit of the present invention.

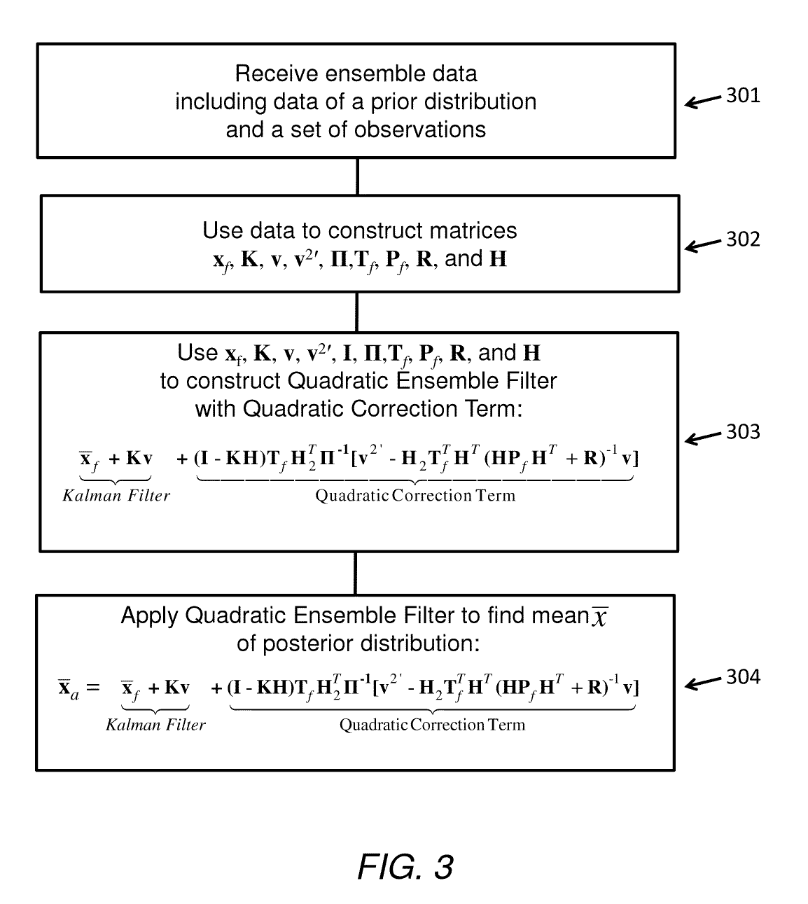

The general case, aspects of which are illustrated in the process flow diagram shown in FIG. 3, describes overall aspects of a method for finding the mean x̅ₐ of a skewed posterior distribution using an appropriately programmed computer and the general form of a Quadratic Ensemble Filter in accordance with the present invention. Thus, in a first step 301, the computer receives data representing a prior distribution ρ(x|x_{f}) derived given a previous estimate of the true state x_{f} and data representing a distribution ρ(y|x) of observations y given a particular value of the truth x. In many cases, the data received by the computer will be in matrix form, and if it is not, the computer can put the data in matrix form before proceeding.

Once the prior distribution and the observations have been input into the computer, in a second step 302, the computer can construct the matrices x̅_{f}, K, v, v²′, I, II, T_{f}, P_{f}, R, and H as described above and at step 303 can construct the Quadratic Ensemble Filter based on x̅_{f}, K, v, v²′, I, II, T_{f} P_{f}, R, and H:

$$\underbrace{{\overline{x}}_{f} + Kv}_{Kalman Filter} + \underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}_{QuadraticCorrectionTerm}$$

Then, using the Quadratic Ensemble Filter in accordance with the present invention, at step 304, the computer finds x̅ₐ, the mean of the posterior distribution as shown above with respect to Equation (4), where:

$${\overline{x}}_{a} = \underbrace{{\overline{x}}_{f} + Kv}_{Kalman Filter} + \underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}_{QuadraticCorrectionTerm} .$$

In addition, as noted above, if the prior distribution is not skewed, the third moment matrix T_{f} will be equal to zero, and in such a case, the Quadratic Ensemble Filter in accordance with the present invention reduces to the conventional Kalman filter and

$${\overline{x}}_{a} = \underbrace{{\overline{x}}_{f} + Kv}_{Kalman Filter} .$$

The present invention also provides two additional embodiments of a method for estimating the mean of a skewed posterior distribution. These two additional embodiments reflect the use of the Quadratic Ensemble Filter in accordance with the present invention in two exemplary operational implementations that are common to the art.

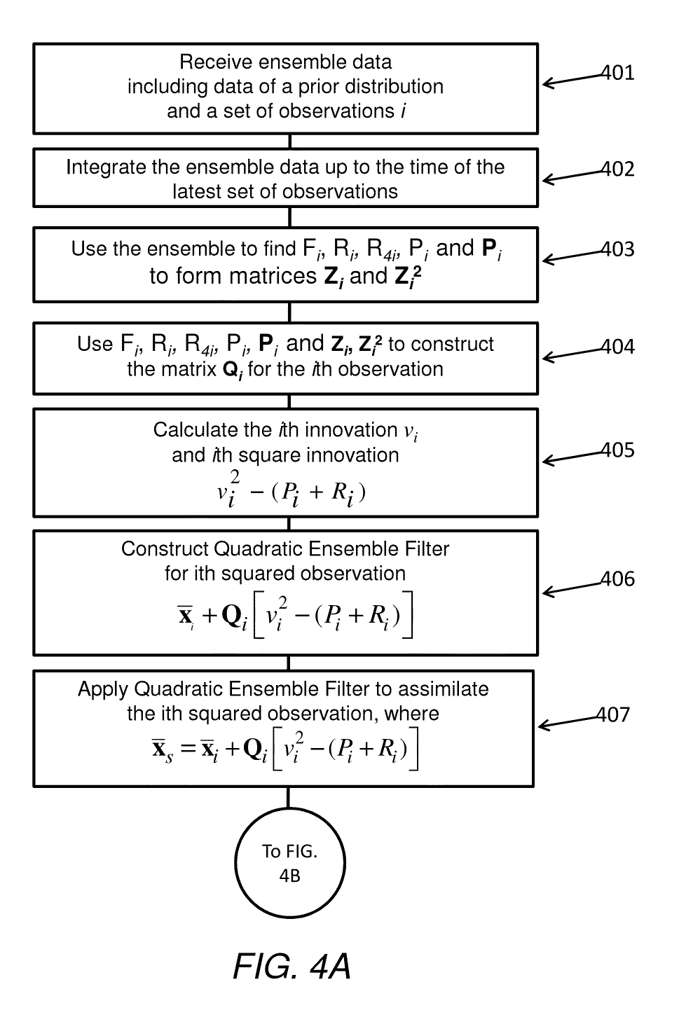

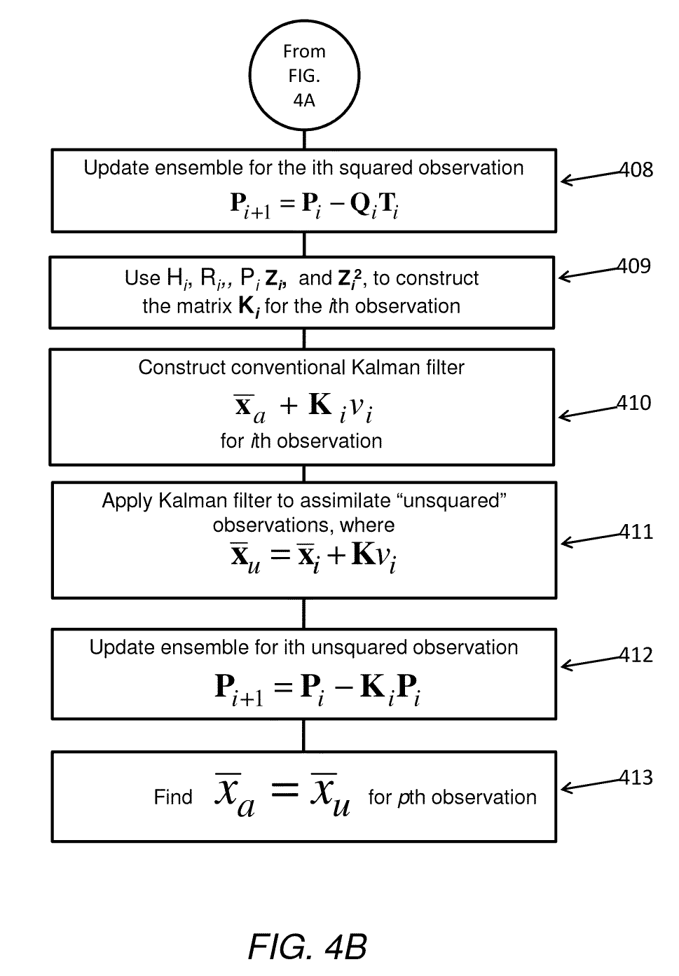

A first exemplary implementation of a Quadratic Ensemble Filter in accordance with the present invention, aspects of which are illustrated in the process flow diagram shown in FIGS. 4A and 4B, involves serial observation processing, in which the computer receives ensemble data that includes a prior ensemble distribution and a set of observations i and updates the prior after assimilating each of a given set of observations. A serial observation processing algorithm is useful in situations with a far greater number of observations than can conveniently be stored in memory on memory-limited computing architectures. In a serial observation processing algorithm only a single observation and its corresponding ensemble need be stored in memory. In addition, for the implementation of the Quadratic Ensemble Filter a serial observation processing algorithm can provide a substantial computational benefit through an approximation of the innovation that significantly shortens its length.

In this first exemplary implementation, the computer receives ensemble data that includes a prior ensemble distribution and a set of observations yᵢ, i=1, . . . , p and updates the prior after assimilating each of a given set of observations. The skewness of the distribution is reflected in the third moment between the observation i and the state variables to be updated.

The set of observations yᵢ, i=1, . . . , p is reflected in the innovation for the ith observation, vᵢ=yᵢ−Hᵢ x̅_{f}. In this case, the serial Quadratic Ensemble Filter in accordance with the present invention processes the “squared” observations in the innovation using a Quadratic Ensemble Filter in accordance with the present invention to find the mean x̅ₛ for each “squared observation yᵢ, with x̅ₛ for the ith observation becoming the prior, x̅ᵢ, for the ith+1 observation. Then, after all of the “squared” observations are processed, the computer processes all the “unsquared” observations as if they were traditional observations using a conventional Kalman Filter to find the mean x̅ᵤ for each unsquared observation, with x̅ᵤ for the ith observation becoming the prior, x̅ᵢ, for the ith+1 observation. Finally, after all of the “unsquared” observations are processed, the value of x̅ᵤ for the pth observation is taken to be the estimated mean x̅ₐ of the posterior, i.e., x̅ₐ= x̅ᵤ for the pth observation.

Thus, in this embodiment of a method for data assimilation using a Quadratic Ensemble Filter in accordance with the present invention, at step 401 the computer receives a set of ensemble data, including data of a prior distribution, a set of observations, and a posterior distribution, and at step 402 integrates the ensemble up to the time of the latest set of observations.

Next, at step 403, the computer uses the ensemble to find Fᵢ, Rᵢ, and R₄ᵢ for the ith observation and Pᵢ and Pᵢ for the ith prior, where Fⁱ= [symbol] εᵢ⁴ [symbol] , Rᵢ= [symbol] ε₀ᵢ² [symbol] , R₄ᵢ= [symbol] ε₀ᵢ⁴ [symbol] , Pᵢ= [symbol] εᵢ² [symbol] and Pᵢ= [symbol] εᵢεᵢ^{T} [symbol] , and where εᵢ represents an error drawn from the ith prior distribution and ε₀ᵢ represents an error drawn from the ith observation, and then forms matrices Zᵢ and Zᵢ², where Zᵢ is the square root of the ith prior error covariance matrix Pᵢ of Equation (12) and Zᵢ² is the “square” of the square root of the prior, i.e.,

Zᵢ²=[(x₁− x̅ᵢ)²−(Pᵢ)(x₂− x̅ᵢ)²−(Pᵢ) . . . (x_{K}− x̅ᵢ)²−(Pᵢ)], (13)

where the subscript refers to the ensemble member such that the Zᵢ² matrix has the same number of rows as the number of state variables and the same number of columns as the number of ensemble members.

At step 404, using Fᵢ, Rᵢ, R₄ᵢ, Pᵢ, Zᵢ, and Zᵢ² constructed in step 403, the computer constructs the matrix Qᵢ for the ith observation, where

Qᵢ=ZᵢZᵢ^{2T}H¹(Fᵢ+6RᵢPᵢ+R₄ᵢ−(Pᵢ+Rᵢ)²)⁻¹. (14)

At step 405, the computer calculates the squared innovation vᵢ²−(Pᵢ+Rᵢ) for the ith observation and the covariances Pᵢ and Rᵢ calculated in step 403.

Then, at step 406 the computer constructs the serial Quadratic Ensemble Filter for the ith observation

x̅ᵢ+Qᵢ[vᵢ²−(Pᵢ+Rᵢ)] (15)

and at step 407 finds x̅ₛ for each “squared observation, using a Quadratic Ensemble Filter in accordance with the present invention for the ith observation, wherein:

x̅ₛ= x̅ₓ+Qᵢ[vᵢ²−(Pᵢ+Rᵢ)]. (15)

with x̅ₛ for the ith observation becoming the prior, x̅ᵢ, for the ith+1 observation.

At step 408, the computer then updates the ensemble for the ith+1 “squared” observation

Pᵢ₊₁=Pᵢ−QᵢTᵢ, (15)

where Pᵢ is the ith posterior error covariance.

After all the “squared” observations have been assimilated, the computer then proceeds to assimilate the “unsquared” observations yₗ using a conventional Kalman filter.

Thus, at step 409, using Fᵢ, Rᵢ, R₄ᵢ, Pᵢ, Zᵢ, and Zᵢ² the computer constructs a matrix Kᵢ for the ith observation, where

Kᵢ=ZᵢZᵢ^{T}Hᵢ^{T}/(Pᵢ+Rᵢ) (15)

and step 410 constructs a conventional Kalman filter for the ith observation:

xᵢ+Kᵢvᵢ (15)

At step 411, the computer then assimilates all of the “unsquared” observations yᵢ using this Kalman filter, where

x̅ᵤ= x̅ᵢ+Kᵢvᵢ (15)

with x̅ᵤ for the ith observation becoming the prior, x̅ᵢ, for the ith+1 observation.

At step 412, the computer updates the ensemble ith+1 “unsquared” observation with an ensemble update having the form:

Pᵢ₊₁=Pᵢ−KᵢPᵢ. (15)

Finally, at step 413, the computer updates the ensemble posterior distribution to reflect the improvement in the estimated posterior mean provided by the ith observation, and repeats the process for each of the remaining observations, and when all p unsquared observations have been processed, the value of x̅ᵤ for the pth observation is taken to be the estimated mean x̅ₐ of the posterior, i.e., x̅ₐ= x̅ᵤ for the pth observation.

This serial-solve approach to implementing the Quadratic Ensemble Filter allows for significant savings in the amount of memory required by the users computing facilities. In addition, this approach is easily implemented within an already constructed serial-solve Kalman filter because the approach simply requires considering the squared observations as an additional set of observations.

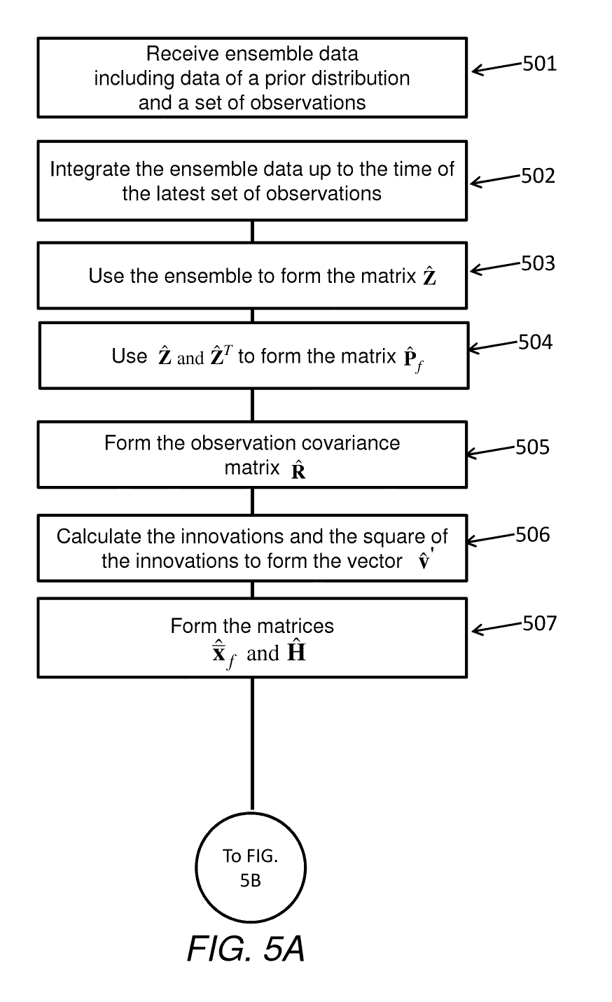

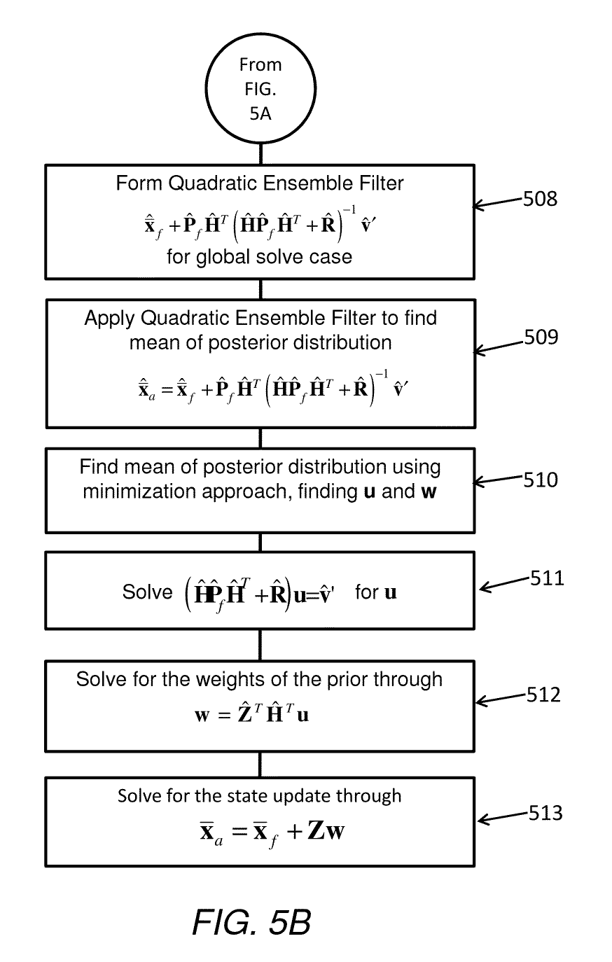

In a second exemplary implementation, aspects of which are illustrated in the process flow diagrams shown in FIGS. 5A and 5B, the present invention provides a method for estimating the mean of a skewed posterior distribution in a data assimilation system using global observation processing. Global observation processing allows for the consideration of all observations at one time. This form of observation processing requires considerably more computational power to implement, but is generally considered to be more accurate as it requires fewer assumptions to implement.

In this second exemplary implementation, at step 501, the computer receives ensemble data describing a prior distribution, a set of observations, and an extended operator Ĥ, which operates on both regular state-vectors and squared state-vectors. As described above, the computer can determine the skewness of the prior distribution by calculating its third moment.

Once the third moment of the prior distribution has been determined, at step 502, the computer integrates the ensemble up to the time of the latest set of observations and then at step 503 uses the ensemble data to form the matrix \hat{Z}:

$$\hat{Z} = [ \begin{matrix}{x}_{1} - {\overline{x}}_{f} & {x}_{2} - {\overline{x}}_{f} & … & {x}_{K} - {\overline{x}}_{f} \\ {( {x}_{1} - {\overline{x}}_{f} )}^{2} - {( {P}_{f} )}_{d} & {( {x}_{2} - {\overline{x}}_{f} )}^{2} - {( {P}_{f} )}_{d} & … & {( {x}_{K} - {\overline{x}}_{f} )}^{2} - {( {P}_{f} )}_{d}\end{matrix} ] \qquad ( 16 )$$

where \hat{Z} is calculated from a Monte-Carlo (ensemble) perspective by constructing the square root from the ensemble and each column is one member of the ensemble and each column is composed of a concatenation of the state vector and the square of each element of the state vector.

At step 504, the computer calculates the prior error covariance matrix \hat{P}_{f}:

$${\hat{P}}_{f} = \hat{Z} {\hat{Z}}^{T} = [ \begin{matrix}{P}_{f} & {T}_{f} \\ {T}_{f}^{T} & {F}_{f} - {( {P}_{f} )}_{d} {( {P}_{f} )}_{d}^{T}\end{matrix} ] , \qquad ( 17 )$$

where (P_{f})_{d}=diag(P_{f}) is a column vector and T_{f} is the third moment matrix and F_{f} is the fourth moment matrix.

At step 505, the computer can then compute the observation error covariance matrix \hat{R}, which is diagonal and is constructed according to:

$$\hat{R} = [ \begin{matrix}R & {R}_{3} \\ {R}_{3} & {R}_{4} - {( R )}_{d} {( R )}_{d}^{T} + 4 R ⊙ ( {HP}_{f} {H}^{T} )\end{matrix} ] \qquad ( 17 )$$

where (R)_{d}=diag(R), R₃ is a generally diagonal matrix containing the third moments of the observational likelihood, and R₄ is the fourth moment matrix of the observational likelihood.

At step 506, the computer then computes the innovation \hat{v}′. In this case, the same approximation is made as in the serial processing embodiment described above, and only those elements of the innovation that are linear direct quadratic products of the innovation are included (i.e., no cross-products between observations). The innovation \hat{v}′ may constructed from the following formula:

\hat{v}=[v^{T}(v⊙v)^{T}]^{T}−[ [symbol] v [symbol] ^{T} [symbol] (v⊙v) [symbol] ^{T}]^{T}, (17)

where the square of the innovation is denoted by: (v⊙v)^{T}=[v₁² v₂² . . . vᵢ² . . . ] and the “⊙” symbol represents the Schur/Hadamard (element-wise) product of two vectors.

At step 507, the computer finds the mean x̅_{f} of the prior distribution and the operator Ĥ. Then, using \hat{x}_{f}, \hat{P}_{f}, Ĥ and \hat{v}′ found as described above, in accordance with the present invention, at step 508 the computer constructs the Quadratic Ensemble Filter for the global solve case:

x̅_{f}+Z\hat{Z}^{T}Ĥ^{T}(Ĥ\hat{P}_{f}Ĥ^{T}+\hat{R})⁻¹\hat{v}′. (18)

and at step 509 finds the mean \overline{\hat{x}} of the posterior distribution, where:

x̅ₐ= x̅_{f}+Z\hat{Z}^{T}Ĥ^{T}(Ĥ\hat{P}_{f}Ĥ^{T}+\hat{R})⁻¹\hat{v}′. (19)

Localization is performed using a variant of the method of described in Bishop, C. H., D. Hodyss, P. Steinle, H. Sims, A. M. Clayton, A. C. Lorenc, D. M. Barker, and M. Buehner, 2011: Efficient ensemble covariance localization in variational data assimilation, Mon. Wea. Rev., 139, 573-580) (Bishop 2011, the entirety of which is hereby incorporated by reference into the present disclosure). In this method we localize the prior error covariance matrix \hat{P}_{f} in Equation (17) by performing a Schur/Hadamard product of \hat{P}_{f} with a localization matrix. As described in Bishop 2011, this requires construction of the square root of the localization matrix for computational expediency.

Equation (19) is then solved using a minimization approach. At step 510, the computer solves (Ĥ\hat{P}_{f}Ĥ^{T}+\hat{R})=\hat{v}′ for u. Note that (Ĥ\hat{P}_{f}Ĥ^{T}+\hat{R}) is symmetric and therefore amenable to many minimization techniques. The computer then at step 511 solves for the weights of the prior through w=\hat{Z}^{T}Ĥ^{T}u and at step 512 solves for the state update through x̅ₐ= x̅_{f}+Zw.

This global-solve approach stays closest to the theoretical ideal presented in the Quadratic Correction Term and therefore is likely to be the most useful in practice. The cost of this accuracy is the significant computational requirements of the method. Nevertheless, if one already has a global-solve Kalman filter system then relatively minor modifications are necessary to extend that system to perform as a Quadratic Ensemble Filter.

Advantages and New Features

The main advantage of the implementation of quadratic innovations (observations) in the state estimation problem is the ability to adapt to non-normal distributions. Through the prior error forecast covariance matrix \hat{P}_{f} of Equation (17) above, it is easily seen how the third and fourth moments can be used to modify the state estimate. Recall that the Kalman filter, which is the most commonly used technique for state estimation, makes use of only second moments and therefore cannot account for curvature in the posterior distribution.

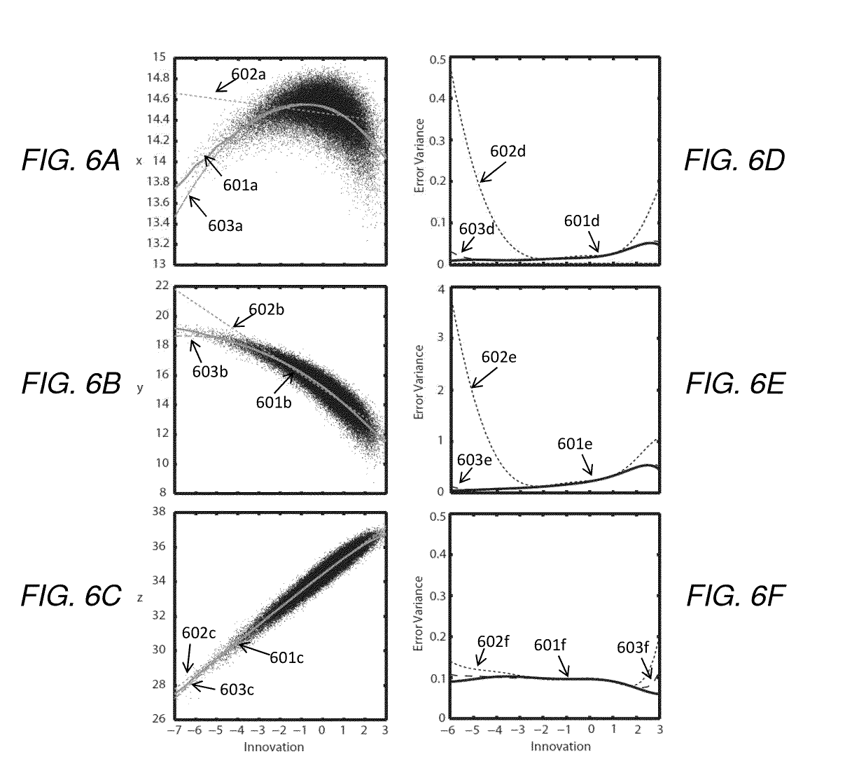

Another example of the significant advantages of using quadratic innovations is illustrated in FIGS. 6A-6F, which illustrate aspects of the advantages of using a Quadratic Ensemble Filter in accordance with the present invention for cases where the system being estimated is a nonlinear Lorenz system and explicitly illustrate that data assimilation and post-processing is attempting to find a curved solution that minimizes error in the state estimate.

The Lorenz system is a 3-variable (x, y, z) nonlinear system that is often used in data assimilation studies to test new algorithms for their behavior in non-Gaussian systems (i.e. skewed prior and posterior distributions).

FIG. 6A illustrates application of the Quadratic Ensemble Filter technique of the present invention on the Lorenz equations. The scatter diagrams in FIGS. 6A, 6B, and 6C show the posterior distribution for the x, y, and z variables, respectively, where:

$$\begin{matrix}\frac{d x}{d t} = σ ( y - x ) , & ( 20 ) \\ \frac{d y}{d t} = x ( r - z ) - y , & ( 21 ) \\ \frac{d z}{d t} = xy - β z , & ( 22 )\end{matrix}$$

where the parameters will be (σ,r,β)=(10,28,8/3). In this example, the system of Equations (20)-(22) will be solved numerically using the explicit Runge-Kutta (4,5) solver (ode45) found in recent versions of MATLAB.

We perform an integration starting from a point (initial condition) off the attractor and integrate long enough (ten units of time) that we are assured that we have arrived on the attractor. We take this new state and perturb it 100,000 times with normally distributed random noise with mean zero and variance 0.01 and subsequently integrate each perturbed state for one unit of time to form an ensemble to estimate the first four moments of the prior distribution. We chose one unit of time because we felt that this was sufficiently long that the ensemble with such small initial variance was now entirely lying on the attractor but not so long that the distribution of members spread unrealistically far from each other in the context of ensemble data assimilation.

Next, we assume that this ensemble is the true prior distribution and randomly observe the variable z of members of this prior with observation error variance of 0.1. This procedure determines the posterior distribution as a function of the innovation and is plotted in FIGS. 6A-6C for each variable in the state vector (i.e., x, y, and z), where the scatter of dots in each plot represents random draws from the posterior distribution and the solid gray line 601a/601b/601c represents the posterior mean.

Recall that our stated goal is to determine the posterior mean from observations and the prior ensemble. The most commonly used technique to accomplish this task is the conventional Kalman filter, whose estimate of the posterior mean is plotted as the short dashed line 602a/602b/602c in FIGS. 6A/6B/6C. However, as can easily be seen in FIGS. 6A/6B/6C, the Kalman filter is incapable of capturing the curvature of the posterior mean as a function of the innovation.

In contrast, by using quadratic innovations v² as described by Equation (4) above, an estimate can be obtained, shown by the long dashed lines 603a/603b/603c, which very closely approximates the posterior mean. Developing state estimation techniques that better follow the posterior mean is significant because this has a large influence on the resulting error in the estimate.

The desirable results of this approach can be seen in FIGS. 6D/6E/6F. FIGS. 6D/6E/6F are plots of the error variance of the posterior mean (solid lines 601d/601e/601f) and the estimate from the Kalman filter (short dashed lines 602d/602e/602f) and the quadratic innovation technique (long dashed lines 603d/603e/603f). Recall that the error variance is simply the squared error one should expect during any given application of the technique to the particular posterior distribution in the sample problem. The true (but unknown) posterior mean has the smallest error possible. Subsequently, our goal is to get as close as possible to this estimate. As can readily be seen in FIGS. 6D/6E/6F, the Kalman filter makes enormous errors for relatively large innovations, while the quadratic innovation technique stays very close to the optimal error variance of the true posterior mean.

Alternatives

Several alternatives to the serial and global observation techniques illustrated above are possible. Both those implementations of the quadratic innovation philosophy neglected cross-products of innovations because of computational expediency. If, however, one wished to apply the technique to a system with small computational overhead then retaining all possible products of the innovation (observations), as described by Equation (4) above, would allow for the most significant improvement in performance over that of the Kalman filter.

Additionally, it is simple to extend the quadratic observation philosophy to higher order terms in Equation (4). For example, one could extend Equation (4) to the cubic term, with the p³ vector and re-derive equations (12), (12), and (12) for f₀, M₁, M₂, and now a new term M₃. This would now include cubic powers of the innovation vector and would provide an even better fit to the curvature of the posterior mean and subsequently a state estimate with smaller expected error.

Thus as described herein the present invention provides a new form of Kalman Filter, the Quadratic Ensemble Filter, which enables a better estimation of the true state of the posterior distribution in cases where the posterior distribution is not Gaussian by more accurately estimating the posterior mean, and provides methods for using the Quadratic Ensemble Filter in accordance with the present invention to find the posterior mean using both serial observation processing and a global observation technique.

As would be appreciated by one of ordinary skill in the art, one or more aspects of a method for finding the mean of a posterior distribution as described herein can be accomplished by one or more processors executing one or more sequences of one or more computer-readable instructions read into a memory of one or more general or special-purpose computers configured to execute the instructions. In addition, where the methods in accordance with the present invention are described in the context of a process flow, one skilled in the art would readily recognize that the order of the steps described need not be followed in all cases but, rather, may be varied as appropriate.

In addition, although particular embodiments, aspects, and features have been described and illustrated, one skilled in the art would readily appreciate that the invention described herein is not limited to only those embodiments, aspects, and features but also contemplates any and all modifications within the spirit and scope of the underlying invention described and claimed herein, and such combinations and embodiments are within the scope of the present disclosure.

What is claimed is:

1. A computer-implemented method for estimating a mean x̅ₐ of a posterior distribution, comprising:
receiving, at a computer programmed with appropriate software, ensemble data representing a skewed prior distribution ρ(x|x_{f}) and data representing an observation distribution ρ(y|x), the prior distribution and the observation distribution implying a skewed posterior distribution ρ(x|x, x_{f});
calculating, at the computer, a mean x̅_{f} of the prior distribution;
receiving, at the computer, data representing an observation matrix H which takes x̅_{f} into p-dimensional observation space;
constructing, at the computer, an innovation v=y−H x̅_{f} and v^{2′}=v²− [symbol] v² [symbol] , where v²=(v\hat{×}v)=[v₁v^{T} v₂v^{T} . . . v_{P}v^{T}]^{T};
constructing, at the computer, the matrices P_{f}= [symbol] ε_{f}ε_{f}^{T} [symbol] , T_{f}= [symbol] ε_{f}ε_{f}^{2T} [symbol] , F_{f}= [symbol] ε_{f}²ε_{f}^{2T} [symbol] , R= [symbol] ε₀ε₀^{T} [symbol] , R₃= [symbol] ε₀ε₀^{2T} [symbol] , and R₄= [symbol] ε₀²ε₀^{2T} [symbol] , where P_{f} is the second moment matrix for the prior distribution, ε_{f} represents an error drawn from the prior distribution, ε₀ represents an error drawn from an observation likelihood, T_{f} is the third moment matrix for the prior distribution, F_{f} is the fourth moment matrix for the prior, R is the second moment matrix for the observations, R₃ is the third moment matrix for the observations, and R₄ is the fourth moment matrix for the observations;
constructing, at the computer, the matrices A= [symbol] εₒ²(Hε_{f})^{2T} [symbol] + [symbol] (Hε_{f})^{2T}εₒ^{2T} [symbol] , B=R\hat{×}HP_{f}H^{T}+HP_{f}H^{T}\hat{×}R, C= [symbol] (εₒε_{f}^{T}H^{T})\hat{×}(Hε_{f}εₒ^{T}) [symbol] + [symbol] (Hε_{f}εₒ^{T})\hat{×}(εₒε_{f}^{T}H^{T}) [symbol] , and H₂=H\hat{×}H;
constructing, at the computer, the matrix K=P_{f}H^{T}(HP_{f}H^{T}+R)⁻¹;
constructing, at the computer, the matrix π=H₂F_{f}H₂^{T}+A+B+C+R₄−H₂T_{f}^{T}H^{T}(HP_{f}H^{T}+R)⁻¹HT_{f}H₂^{T}− [symbol] v² [symbol] [symbol] v^{2T} [symbol] ;
constructing, at the computer, a Quadratic Ensemble Filter having the form
$$\underbrace{{\overline{x}}_{f} + Kv}_{Kalman Filter} + \underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}_{QuadraticCorrectionTerm} ,$$
wherein the Quadratic Correction Term includes the quadratic form of the innovation v and the third and fourth moments of the prior distribution; and
calculating, at the computer, x̅ₐ, an estimated mean of the posterior distribution, wherein
$${\overline{x}}_{a} = \underbrace{{\overline{x}}_{f} + Kv}_{Kalman Filter} + \underbrace{( I - KH ) {T}_{f} {H}_{2}^{T} {Π}^{- 1} [ {v}^{{2}^{′}} - {H}_{2} {T}_{f}^{T} {{H}^{T} ( {HP}_{f} {H}^{T} + R )}^{- 1} v ]}_{QuadraticCorrectionTerm} .$$

2. A computer-implemented method for estimating a mean x̅ₐ of a skewed posterior distribution in a data assimilation system using serial observation processing, comprising:
receiving, at a computer programmed with appropriate software, ensemble data regarding a skewed prior distribution ρ(x|x_{f}), data representing an observation distribution ρ(yᵢ|x) of observations yᵢ, i=1, . . . p, the prior distribution and the observation distribution implying a skewed posterior distribution ρ(x|x, x_{f});
calculating, at the computer, a mean x̅ᵢ of the prior distribution for the ith observation;
receiving, at the computer, data representing an observation matrix H;
determining, at the computer, Fᵢ, Rᵢ, and R₄ᵢ for the ith observation and Pᵢ and Pᵢ for the ith prior, where Fᵢ= [symbol] εᵢ⁴ [symbol] , Rᵢ= [symbol] ε₀ᵢ² [symbol] , R₄ᵢ= [symbol] ε₀ᵢ⁴ [symbol] , Pᵢ= [symbol] εᵢ² [symbol] and Pᵢ= [symbol] εᵢεᵢ^{T} [symbol] and where εᵢ represents an error drawn from the ith prior distribution and ε₀ᵢ represents an error drawn from the ith observation;
constructing, at the computer, matrices Zᵢ and Zᵢ², where Zᵢ is the square root of the ith prior error covariance matrix Pᵢ and Zᵢ² is
Zᵢ²=[x₁− x̅ᵢ)²−vec(Pᵢ)(x₂− x̅ᵢ)²−vec(Pᵢ) . . . (x_{K}− x̅ᵢ)²−vec(Pᵢ)];
constructing, at the computer, a matrix Qᵢ for the ith observation, where
Qᵢ=ZᵢZᵢ^{2T}Hᵢ^{T}(Fᵢ+6RᵢPᵢ+R₄ᵢ−(Pᵢ+Rᵢ)²)⁻¹;
calculating, at the computer, an innovation vᵢ=yᵢ−H x̅ᵢ for the ith observation and squared innovation vᵢ²−(Pᵢ+Rᵢ) for the ith observation;
constructing, at the computer, a Quadratic Ensemble Filter for the ith observation having the form x̅ᵢ+Qᵢ[vᵢ²−(Pᵢ+Rᵢ)];
calculating, at the computer, x̅ₛ, an estimated mean of the posterior distribution for each ith observation through the Quadratic Ensemble Filter for the ith observation, wherein x̅ₛ= x̅ᵢ+Qᵢ[vᵢ²−(Pᵢ+Rᵢ)] and x̅ₛ for the ith observation becoming the prior, x̅ᵢ, for the ith+1 observation;
updating the ensemble data with an ensemble update Pᵢ₊₁=Pᵢ−QᵢTᵢ
constructing, at the computer, a Kalman filter for the ith unsquared observation, the Kalman filter having the form x̅ᵢ+Kᵢvᵢ, where Kᵢ=ZᵢZᵢ^{T}Hᵢ^{T}/(Pᵢ+Rᵢ);
calculating at the computer, x̅ᵤ for each unsquared observation using the Kalman Filter, wherein x̅ᵤ= x̅ᵢ+Kᵢvᵢ and
updating the ensemble data for the with an ensemble update Pᵢ₊₁=Pᵢ−KᵢPᵢ
finding x̅ₐ, the mean of the posterior distribution, wherein x̅ₐ= x̅ᵤ for the pth observation.

3. A computer-implemented method for finding a mean x̅ₐ of a posterior distribution in a data assimilation system using global observation processing, comprising:
receiving, at a computer programmed with appropriate software, ensemble data representing a skewed prior distribution ρ(x|x_{f}) and data representing an observation distribution ρ(y|x), the prior distribution and the observation distribution implying a skewed posterior distribution ρ(x|x, x_{f});
calculating, at the computer, a mean x̅_{f} of the prior distribution;
receiving, at the computer, data representing an observation matrix H;
calculating, at the computer, a matrix \hat{Z} having the form
$$\hat{Z} = [ \begin{matrix}{x}_{1} - {\overline{x}}_{f} & {x}_{2} - {\overline{x}}_{f} & … & {x}_{K} - {\overline{x}}_{f} \\ {( {x}_{1} - {\overline{x}}_{f} )}^{2} - {( {P}_{f} )}_{d} & {( {x}_{2} - {\overline{x}}_{f} )}^{2} - {( {P}_{f} )}_{d} & … & {( {x}_{K} - {\overline{x}}_{f} )}^{2} - {( {P}_{f} )}_{d}\end{matrix} ] ,$$
where \hat{Z} is the square root of the extended covariance matrix for the prior;
calculating, at the computer, T_{f}= [symbol] ε_{f}ε_{f}^{2T} [symbol] , F_{f}= [symbol] ε_{f}²ε_{f}^{2T} [symbol] ), R= [symbol] ε₀ε₀^{T} [symbol] , R₃= [symbol] ε₀ε₀^{2T} [symbol] , and R₄= [symbol] ε₀²ε₀^{2T} [symbol] , where T_{f} is the third moment matrix for the prior distribution, F_{f} is the fourth moment matrix for the prior, R is the second moment matrix for the observations, R₃ is the third moment matrix for the observations, and R₄ is the fourth moment matrix for the observations;
calculating, at the computer, is the prior error covariance matrix
$${\hat{P}}_{f} = \hat{Z} {\hat{Z}}^{T} = [ \begin{matrix}{P}_{f} & {T}_{f} \\ {T}_{f}^{T} & {F}_{f} - {( {P}_{f} )}_{d} {( {P}_{f} )}_{d}^{T}\end{matrix} ] ,$$
where (P_{f})_{d}=diag(P_{f});
calculating, at the computer, the observation error covariance matrix
$$\hat{R} = [ \begin{matrix}R & {R}_{3} \\ {R}_{3} & {R}_{4} - {( R )}_{d} {( R )}_{d}^{T} + 4 R ⊙ ( {HP}_{f} {H}^{T} )\end{matrix} ] ;$$
calculating, at the computer, an innovation \hat{v}′=[v^{T} (v⊙v)^{T}]^{T}−[ [symbol] v [symbol] ^{T} [symbol] (v⊙v) [symbol] ^{T}]^{T}, where (v⊙v)^{T}=[v₁² v₂² . . . vᵢ² . . . ] is the square of the innovation;
calculating, at the computer, a Quadratic Ensemble Filter having the form \overline{\hat{x}}_{f}+\hat{P}_{f}Ĥ^{T}(Ĥ\hat{P}_{f}Ĥ^{T}+\hat{R})⁻¹\hat{v}′ wherein the Quadratic Ensemble Filter includes the third and fourth moments of the prior distribution; and
calculating, at the computer, x̅ₐ, an estimated mean of the posterior distribution, wherein \overline{\hat{x}}ₐ= \overline{\hat{x}}_{f}+\hat{P}_{f}Ĥ^{T}(Ĥ\hat{P}_{f}Ĥ^{T}+\hat{R})⁻¹\hat{v}′.
